(19) United States
(12) Patent Application Publication
(10) Pub. No.: US 2006/0091574 A1
(43) Pub. Date: May 4, 2006

(54) INTERIOR VEHICLE TRIM PANEL HAVING A SPRAYED EXPANDED POLYURETHANE LAYER AND METHOD AND SYSTEM OF MAKING SAME

(75) Inventors: Andrew P. Mellentine, Owosso, MI (US); Joseph T. Donatti, Howell, MI (US); Jerome J. Sroka, St. Clair Shores, MI (US); Ian S. Williams, Howell, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/904,306

(22) Filed: Nov. 3, 2004

(51) Int. Cl. B29C 44/12

(52) U.S. Cl. 264/46.4; 264/309; 425/103; 425/4 R

(57) ABSTRACT

Aspects of the present invention include interior vehicle trim panel having a sprayed expanded polyurethane layer and method of making same. In at least one embodiment, the method of making the vehicle interior trim panel comprises providing a skin layer on a spray tool, providing a source of polyol, and providing a source of isocyanate, wherein at least one of the sources contains a nucleated component. The method of this embodiment further comprises combining polyol and isocyanate from the respective sources to form expandable polyurethane reactive component, spraying the expandable polyurethane reactive component onto the skin layer to form a resilient layer, and securing a rigid substrate to the resilient layer to form the vehicle interior trim part.

### BACKGROUND OF THE INVENTION

1. Field of the Invention

The invention relates to interior vehicle trim panel having a sprayed expanded polyurethane layer, and to a method and system of making such parts.

2. Background Art

One example of a relatively typical vehicle interior trim panel comprises a relatively rigid substrate having a relatively flexible thin plastic skin disposed over at least an interior facing portion of a surface of the substrate. For some panels where a softer touch is desired, foam has been provided between the substrate and the skin. For these types of panels, a foam in place process is often times used to provide the foam. In this type of process, the skin and the substrate are positioned spaced apart in a mold while foam is molded there between. After the foam is molded, the foam extends between and secures the skin to the substrate.

There are occasions where trim panels having a soft feel are desired but because of design constraints are not easily manufacturable. One example is of a door panel having a soft feel above the belt line to match the appearance and feel of the instrument panel. Another example is of a trim panel, such as a door panel or instrument panel, that has undercuts, sharp radii, or other design configuration that results in relatively small, or somewhat significantly uneven, clearances between the skin and the substrate. In these, and other, types of designs, foam in place may have drawbacks that could prevent such a technique from being a suitable option.

### SUMMARY OF THE INVENTION

Under the invention, a method of making a vehicle interior trim panel is provided. In at least one embodiment, the method includes providing a skin layer on a spray tool, providing a source of polyol, and providing a source of isocyanate, wherein at least one of the sources contains a nucleated component. The method of this embodiment further comprises combining polyol and isocyanate from their sources to form expandable polyurethane reactive component, spraying the expandable polyurethane reactive component onto the skin layer to form a resilient layer, and securing a rigid substrate to the resilient layer to form the vehicle interior trim part.

In at least one embodiment of the invention, the resilient layer has a density of 0.1 to 0.75 g/cm³. In at least another embodiment of the invention, the nucleated component is nucleated polyol having a specific gravity of 0.7 to 0.95. In at least yet another embodiment of the invention, the resilient layer comprises 35-90% closed cell structures.

The present invention also provides a system for making vehicle interior trim panel for use with a motor vehicle. In at least one embodiment, the system comprises a spray tool for receiving a skin layer, a source of polyol, and a source of isocyanate, with at least one of the sources containing a nucleated component and each source is capable of delivering a stream of material combinable with the other stream to form expandable polyurethane reactive component. The system of this embodiment further comprising a spraying device for spraying the expandable polyurethane reactive component onto the skin layer to form a resilient layer, and a device for securing a rigid substrate to the resilient layer to form the vehicle interior trim part.

In at least one embodiment, the present invention also provides a vehicle interior panel for a vehicle interior made in accordance with at least one method and/or system of the present invention.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a perspective view of vehicle interior instrument panel in accordance with at least one aspect the invention for use with a motor vehicle;

FIG. 2 is a cross-sectional view of the door panel taken along line 2-2 of FIG. 1;

FIG. 3 is a schematic view of a spray tool and spray assembly for use in forming a panel, wherein the spray assembly is shown applying material on the tool to form a coating;

FIG. 4 is a schematic view of the tool showing application of additional material onto the coating to form a skin layer;

FIG. 5 is a schematic view of the tool showing application of expandable material onto the skin layer to form a resilient layer; and

FIG. 6 is similar to FIG. 5 showing another aspect of the present invention.

### DETAILED DESCRIPTION OF THE PREFERRED EMBODIMENT(S)

As required, detailed embodiments of the present invention are disclosed herein. However, it is to be understood that disclosed embodiments are merely exemplary of the invention that may be embodied in various alternative forms. The figures are not necessarily to scale, some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims indicating amounts of materials or conditions of reactions and/or use are to be understood as modified by the word “about” in describing the broadest scope of this invention. Practice within the numeral limit stated is generally preferred. Also, unless expressly stated to the contrary, percent, “parts of,” and ratio values are by weight and the description of a group or class of materials as suitable or preferred for a given purpose in connection with the invention implies that mixtures of any two or more members of the group or class may be equally suitable or preferred.

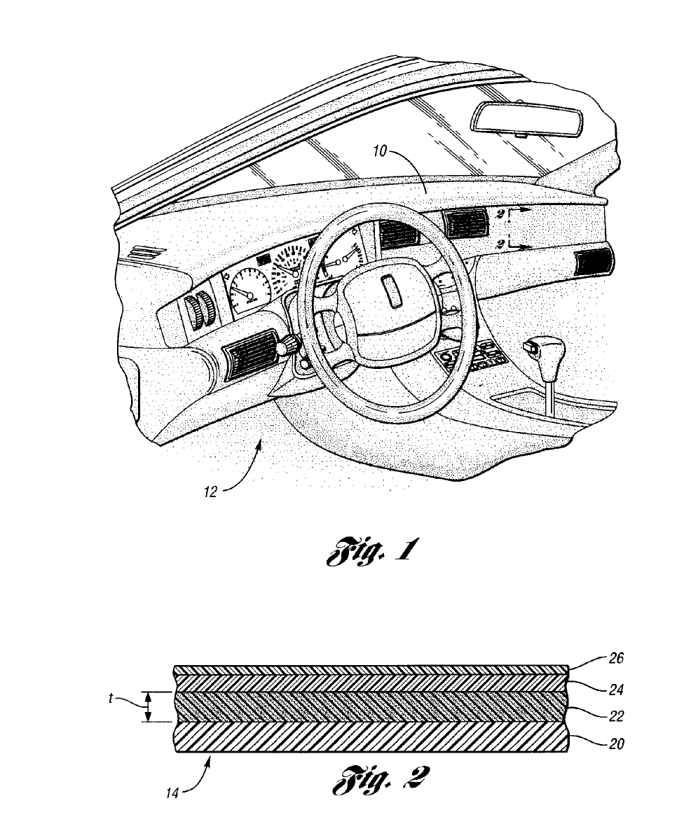

FIGS. 1 and 2 show an interior vehicle trim component, such as an instrument panel 10, in accordance with at least one aspect of the invention for use with a motor vehicle 12. Certain aspects of the present invention will be described below in connection with the instrument panel 10. However, it should be understood that other trim products, such as door panels, door covers, console covers, pillar trim panels, shelves, trim covers and the like can also enjoy the benefits of the present invention.

As shown in FIGS. 1-2, in at least one embodiment, the instrument panel 10 includes a rigid substrate 20, a resilient expanded polyurethane layer 22 attached to the substrate 20, a skin layer 24 attached to the resilient layer 22, and an optional coating 26 that covers the skin layer 24 and provides an exterior appearance surface.

The substrate 20 is a structural member that provides support for the remainder of the instrument panel 10, and may comprise any suitable material. For example, the substrate 20 may be made of plastic or reinforced plastic, such as fiberglass reinforced polyurethane (GRU). Additional examples of suitable plastics, besides polyurethane, include polypropylene, polyethylene, acrylonitrile butadiene styrene (ABS), polycarbonate (PC), and ABS/PC blends. In at least one embodiment, the substrate 20 may have an average thickness between 0.5 to 5 mm, in another embodiment 1.0 to 3.5 mm, and in yet another embodiment 2.0 to 3.0 mm.

In at least one embodiment, the resilient layer 22 is adhered to the substrate 20 and the skin layer 24 and may be configured to help provide a soft feel to the instrument panel 10. The resilient layer 22 may comprise any suitable sprayed expanded polyurethane material. For example, the resilient layer 22 may comprise an expanded aromatic polyurethane elastomer. In at least one embodiment, the density of the resilient layer 22 can be in the range of 0.10 to 0.75 grams per cubic centimeter (g/cm³), in another embodiment between 0.15 to 0.5 g/cm³, and in yet another embodiment 0.2 to 0.3 g/cm³. In at least one embodiment, the resilient layer may have a shore A hardness of 30 to 50.

In at least one embodiment, the resilient layer 22 primarily may comprise a low permeable, relatively closed cell material. In at least one embodiment, the resilient layer 22 may comprise 35 to 90 percent closed cell structures, in at least another embodiment 40 to 75 percent closed cell structures, and in yet at least another embodiment 45 to 60 percent closed cell structures, based upon the entire resilient layer 22.

In at least one embodiment, the resilient layer 22 may have varying closed cell density throughout the resilient layer. In at least one embodiment, the top portion (the portion closer to the skin layer 24) and the lower portion (the portion closer to the substrate 20) may independently comprise at least 85 percent closed cell structures, in other embodiments between 90 to 100 percent closed cell structures, and in yet other embodiments between 95 and 100 percent closed cell structures. In at least one embodiment, the top and bottom portions may independently comprise between 2.5 to 25 percent, in other embodiments between 5 to 20 percent, and in yet other embodiments between 10 to 15 percent, of the thickness t of the resilient layer 22. The remaining intermediate layer (the portion between the top and bottom portion) of the resilient layer 22 may comprise between 40 to 95 percent closed cell structures, in at least another embodiment between 50 to 90 percent closed cell structures, and in yet another embodiment between 60 to 85 percent closed cell structures. In at least one embodiment, the average cell structure size can vary between 0.05 mm to 3.0 mm, and in yet other embodiment between 0.5 mm to 1.0 mm.

The skin layer 24 is adhered to the resilient layer 22 and optional coating 26. Moreover, the skin layer 24 is configured to provide a covering over the resilient layer 22 and may comprise any sufficiently dense material. For example, the skin layer 24 may be a solid layer that comprises an aromatic or aliphatic compound. As a more specific example, the skin layer 24 may be made of an elastomer such as polyurethane. Furthermore, the skin layer 24 may have any suitable thickness and density. For example, the skin layer 24 may have a thickness in the range of 0.4 to 2 mm, and a density in the range of 0.85 to 1.2 g/cm³. In one embodiment of the invention, the skin layer 24 has a thickness in the range of 0.5 to 1.2 mm, and a density in the range of 0.95 to 1.1 g/cm³.

The optional coating 26 may be used to protect the skin layer 24 and/or to provide a decorative surface for the upper door portion 14. For example, the coating 26 may be used to inhibit sunlight and/or other ultraviolet light from reaching the skin layer 24. As another example, the coating 26 may be used as a paint to provide a desired color and/or texture to the upper door portion 14. While the coating 26 may comprise any suitable material, in at least one embodiment of the invention, the coating 26 is made of an aliphatic polyurethane composition. Furthermore, the coating 26 may have any suitable thickness, such as a thickness of approximately 0.5 to 1.0 mil.

Alternatively, the coating 26 may be omitted if not required for a particular application. For example, the skin layer 24 may be configured to provide a sufficiently durable and attractive surface such that the coating 26 is not needed.

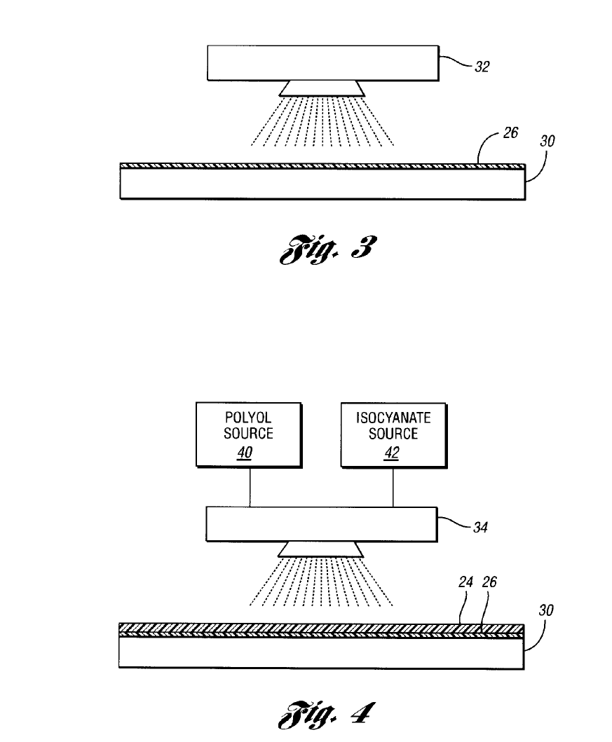

Referring to FIGS. 3-6, a method of manufacturing the instrument panel 10 will now be described. The method may begin by spraying an optional mold release agent and then the optional coating 26 on a spraying mold tool 30 using any suitable device, such as a robotic low pressure (such as 10 to 40 psi) spray assembly 32 having one or more moveable spray nozzles. The tool 30 may be heated to any suitable temperature if desired, generally in the range of 150° C. to 165° C.

Next, referring to FIG. 4, the method involves spraying skin layer forming material onto the coating 26 to form skin layer 24, which bonds to the coating 26. The skin layer forming material may be any suitable sprayable polyurethane forming material (i.e., composition) and may be applied using any suitable device. For example, the material may be sprayed with a high pressure (such as 400 to 2,000 psi) robotic spray assembly 34 having one or more movable spray nozzles. In at least one embodiment, the polyurethane forming material comprises components such as polyol, provided from polyol source 40 and isocyanate, provided from isocyanate source 42. In at least embodiment, the polyurethane forming materials are aromatic and provide an aromatic polyurethane skin layer 24. The polyol and isocyanate, and any other necessary components for forming polyurethane, in at least one embodiment, can be mixed in the spray assembly 34 before being sprayed as the polyurethane forming material onto the coating 26. A CPU can be provided for controlling this operation.

As mentioned above, the coating 26 may be omitted from the upper door portion 14. In such a case, the skin layer forming material may be sprayed directly onto the tool 30, or onto a mold release agent that is applied on the tool 30, to form the skin layer 24. In this embodiment, the polyurethane skin layer 24 is preferably aliphatic.

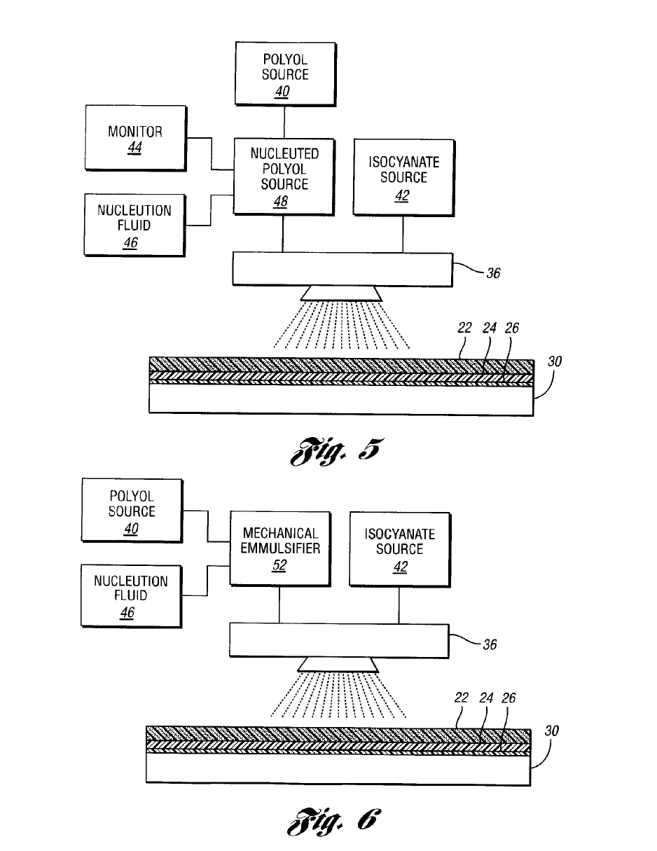

Referring to FIG. 5, the method then involves spraying expandable polyurethane material onto the skin layer 24 to form resilient layer 22, which bonds to skin layer 24. The expandable polyurethane material may be any suitable sprayable expandable polyurethane material (composition) comprising (or made from) a nucleated component and may be sprayed in any suitable manner.

As is well known in the art, the primary components of polyurethane are polyol and isocyanate. As such, it should be understood that the nucleated component could be nucleated polyol, nucleated isocyanate, or both. A “nucleated material” should be understood to mean a “frothed material” or a material having a lower density compared to the unnucleated material caused at least in part by the mechanical mixing of liquid and/or gaseous low boiling point gas/bubble generating agent (such as carbon dioxide), into the material. In at least one preferred embodiment, the nucleated component material is nucleated polyol. As such, in the remainder of this description, the nucleated component will be referred to in a non-limiting manner as nucleated polyol, however it should be understood that the nucleated component may be something other than that, such as nucleated isocyanate, as described above. In at least one embodiment, the expandable polyurethane material comprises nucleated polyol from nucleated polyol source 40, isocyanate from isocyanate source 42, and any other necessary components for forming polyurethane.

In at least one embodiment, nucleated polyol is polyol that has experienced a 5 to 25% reduction in specific gravity. In certain embodiments, the nucleated polyol has a specific gravity of 0.70 to 0.95, and in other embodiments of 0.75 to 0.85.

As shown in FIG. 5, a nucleated polyol source 48 is provided. A monitor 44, a nucleation source 46, and a polyol source 40 can be in communication with the nucleated polyol source 48 to monitor and adjust as needed the level of nucleation in the nucleated polyol source 48. In at least one embodiment, the nucleation fluid/source 46 can comprise bubble causing nucleation fluid such as liquid and/or gaseous carbon dioxide (CO₂), nitrogen (N₂) freon 141b, freon R-22, cyclopentane, or other suitable low boiling point bubble forming agent. In at least one embodiment, the nucleation fluid 46 vaporizes (or further vaporizes) and expands when introduced into the spray assembly 36 and/or the atmosphere during spraying. The monitor 44 can be any suitable monitor or flow meter for monitoring the specific gravity of the nucleated polyol in the nucleated polyol source 40. Examples of suitable monitors and other components useful with the invention include components and/or systems from the Multi Easy Froth™ System available from Cannon USA of Pittsburgh, Pa.

In at least one embodiment, the expandable polyurethane material may be sprayed with the same type of robotic spray assembly 36 as used in FIG. 4, and the material may be allowed to free rise to achieve the desired density. Alternatively, the same spray assembly 34 as used in FIG. 4 could be used to spray the expandable polyurethane material. Furthermore, polyol source 40 in FIG. 4 could be the same as polyol source 40 in FIG. 5. In other words, the same polyol source 40 and/or spray assembly 34 could be used in the steps shown in FIGS. 4 and 5.

It should be understood that the expandable polyurethane material may be sprayed to achieve any desired thickness t at any location, such that the thickness of the resilient layer 22 may be varied. Thus, the expandable polyurethane material may be more lightly applied in certain areas such as where there is less clearance between substrate 20 and skin 24, and more heavily applied in areas, where there is more clearance between substrate 20 and skin 24. Furthermore, an optional embodiment, a layer (not shown) of conventional foam-in-place foam could be conventionally disposed between resilient layer 22 and substrate 20.

Referring to FIG. 6, an alternative system and method to that shown in FIG. 5 for a spraying expanded polyurethane material is illustrated. The polyol source 40, the isocyanate source 42, the nucleation source 46, the spray assembly 36, and mold 30 are the same as those used in the method and system illustrated in FIG. 5. The polyol source 40 contains polyol that has not been nucleated. This polyol has a specific gravity of 1.0 to 1.10. A mechanical emulsifier 52 is provided between the polyol source 40 and the spray assembly 36. The polyol source 40 deliver polyol on demand or as is needed to the spray assembly 36 through the mechanical emulsifier 52. The mechanical emulsifier 52 combines the polyol from polyol source 40 with nucleation fluid from nucleation fluid source 46 to form a nucleated polyol. The nucleated polyol is similar to the nucleated polyol in the nucleated polyol source 40 in FIG. 5. The nucleated polyol is then delivered from the mechanical emulsifier 52 to the spray assembly 36 to mix with the isocyanate to form an expandable polyurethane material that can be sprayed onto skin layer 24 to form resilient layer 22.

In at least one embodiment, the expandable polyurethane material may be sprayed with the same type of robotic spray assembly 36 as used in FIG. 4, and the material may be allowed to free rise to achieve the desired density. Alternatively, the same spray assembly 34 as used in FIG. 4 could be used to spray the expandable polyurethane material in FIG. 6. Furthermore, polyol source 40 in FIG. 4 could be the same as polyol source in FIG. 6. In other words, the same polyol source 40 and/or spray assembly 34 could be used in the steps shown in FIGS. 4 and 6.

In yet another embodiment, nucleation fluid, polyol and isocyanate could be mixed together (not shown) in a spray assembly to form an expandable polyurethane material that can be sprayed onto the skin layer 24 to form resilient layer 22.

Next, the method involves securing the substrate 20 to the expanded polyurethane layer 22. In one embodiment, this can be done by removing the coating 26, skin layer 24 and resilient expanded polyurethane layer 22 from the tool 30 and positioning the layers 22, 24 and 26 in a mold having first and second mold portions. The mold portions may then be closed together, with material being injected into the mold through one or more injection passages (not shown) to form substrate 20, which bonds to the resilient layer 22. Alternatively, the material may be poured into the mold, and then the mold portions may be closed together.

While the substrate material may comprise any suitable substance or substances, in one embodiment, the material includes polyol and isocyanate such that the substrate 20 is formed of polyurethane. Other suitable materials include polypropylene, polyethylene, ABS, PC, ABS/PC blends, GRU and RRIM.

Whether the material is injected or poured into the mold, such a process may be referred to as reaction injection molding (RIM). Reinforcing material such as milled glass or glass fibers may also be added during the RIM process to provide reinforcement to the substrate 20. As another example, a reinforcing mat or preform, such as a fiberglass preform, may be positioned in the mold prior to the RIM process. This process may be referred to as structural reaction injection molding (SRIM). RRIM is the process where milled glass is mixed with polyol before reacting the polyol with the isocyanate.

In at least one embodiment, the substrate 20 could be a preformed substrate that is secured to the layer 22 by suitable means, such as adhesively.

Examples of other vehicle parts that may be manufactured by the above method include instrument panels, door panels, door covers, package shelves, pillar trim panels, trim covers, and console covers.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a vehicle interior trim panel, the method comprising:
providing a skin layer on a spray tool;
providing a source of polyol;
providing a source of isocyanate, wherein at lest one of the sources contains a nucleated component;
combining polyol from the source of polyol and isocyanate from the source of isocyanate to form expandable polyurethane reactive component;
spraying the expandable polyurethane reactive component onto the skin layer to form a resilient layer; and
securing a rigid substrate to the resilient layer to form the vehicle interior trim part.

2. The method of claim 1 wherein the resilient layer has a density of 0.1 to 0.75 g/cm³.

3. The method of claim 2 wherein a substantial portion of the resilient layer has a thickness of 0.1 to 8.0 mm and a shore A hardness of 30 to 50.

4. The method of claim 1 wherein the source of polyol contains nucleated polyol and the nucleated component comprises the nucleated polyol.

5. The method of claim 4 wherein nucleated polyol has a specific gravity of 0.70 to 0.95.

6. The method of claim 5 wherein the step of providing a source of nucleated polyol comprises providing a container containing nucleated polyol.

7. The method of claim 5 wherein the step of providing a source of nucleated polyol comprises directing a source of polyol and nucleation fluid through a mechanical emulsifier to form nucleated polyol.

8. The method of claim 6 wherein the container is in communication with a nucleation source which is activatable to increase the level of nucleation in the source of nucleated polyol in dependence upon the monitor reading.

9. The method of claim 1 wherein the skin layer comprises polyurethane.

10. The method of claim 1 wherein the resilient layer comprises 35-90% closed cell structures.

11. A system of making a vehicle interior trim panel, the system comprising:
a spray tool for receiving a skin layer;
a source of polyol;
a source of isocyanate, wherein at least one of the sources contains a nucleated component and wherein the source of polyol and the source of isocyanate are each capable of delivering material combinable with the other material to form expanded polyurethane reactive component;
a spraying device for spraying the expandable polyurethane reactive component onto the skin layer to form a resilient layer; and
a device for securing a rigid substrate to the resilient layer to form the vehicle interior trim part.

12. The system of claim 11 wherein the resilient layer has a density of 0.1 to 0.75 g/cm³.

13. The system of claim 12 wherein a substantial portion of the resilient layer has a thickness of 0.1 to 8.0 mm and a shore A hardness of 30 to 50.

14. The system of claim 11 wherein the source of polyol contains nucleated polyol and the nucleated component comprises the nucleated polyol.

15. The system of claim 14 wherein nucleated polyol has a specific gravity of 0.70 to 0.95.

16. The system of claim 15 wherein the source of nucleated polyol comprises a container containing nucleated polyol.

17. The system of claim 15 wherein the source of nucleated polyol comprises directing a source of polyol and a source of nucleation fluid selectively directable through a mechanical emulsifier to form nucleated polyol.

18. The system of claim 16 wherein the container is in communication with a monitor to monitor the nucleation level in the nucleated polyol.

19. The system of claim 17 wherein the container is in communication with a nucleation source which is activatable to increase the level of nucleation in the source of nucleated polyol in dependence upon the monitor reading.

20. A vehicle interior trim panel for use with a motor vehicle, the trim panel being made by the process of claim 1.
